(19) United States
(12) Patent Application Publication
(10) Pub. No.: US 2004/0204524 A1
(43) Pub. Date: Oct. 14, 2004

(54) Solvent-containing mixtures which can be cured physically or thermally and/or by means of actinic radiation, method of production and use thereof

(76) Inventors: Hubert Baumgart, Munster (DE); Helmut Kleine Beckmann, Ostbevern (DE); Peter Mayenfels, Munster (DE); Andreas Pyttlik, Hamm (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/478,925

(22) PCT Filed: Jun. 21, 2002
(86) PCT No.: PCT/EP02/06875

(30) Foreign Application Priority Data
Jun. 21, 2001 (DE) 10130069.7

(51) Int. Cl. C08K 5/05

(52) U.S. Cl. 524/385

(57) ABSTRACT

The use of an aromatic-free solvent mixture which consists of or comprises

(A) at least one low-boiling organic solvent and

(B) at least one organic solvent selected from the group consisting of high-boiling and middle-boiling organic solvents,

(1) at least one of the organic solvents (A) and/or (B) having a Hildebrand solubility parameter δ (HSP) of between 10.5 and 12.0 (cal/cm³)^{1/2} and a hydrogen bonding index (HBI) between −15 and −20, and

(2) at least one of the organic solvents, (A) and/or (B), having a Hildebrand solubility parameter δ (HSP) of between 8 and 9.7 (cal/cm³)^{1/2} and a hydrogen bonding index (HBI) between 0 and 12,

to improve the profile of properties of solventborne mixtures curable physically or thermally and/or with actinic radiation and of the products produced from them; and also a mixture curable physically or thermally and/or with actinic radiation that comprises the aromatic-free solvent mixture.

The present invention relates to novel solventborne mixtures curable physically or thermally and/or with actinic radiation. The present invention also relates to a novel process for preparing solventborne mixtures curable physically or thermally and/or with actinic radiation. The present invention additionally relates to the use of the novel solventborne mixtures curable physically or thermally and/or with actinic radiation as coating materials, adhesives, and sealing compounds.

Solventborne mixtures curable physically or thermally and/or with actinic radiation have been known for a long time. The known solventborne mixtures may be pigmented or unpigmented. They are used as pigmented and unpigmented coating materials, adhesives, and sealing compounds, but particularly as pigmented and unpigmented coating materials.

The pigmented and unpigmented coating materials may lead to any of a wide variety of uses. For example, they may serve to coat motor vehicle bodies and parts thereof, the inside and outside of motor vehicles, the inside and outside of buildings, doors, windows, and furniture, and, in the context of industrial coating, for the coating of coils, containers, packaging, small parts, electrical components, and white goods.

Particularly high demands are imposed on the pigmented and unpigmented coating materials in the context of their use for the original (OEM) finishing of motor vehicle bodies and parts thereof and for the refinish of the inside and outside of motor vehicles. The very greatest demands here are imposed in connection with the original finishing and refinish of top-class automobiles. The automobile finishes are generally regarded as the apex of products in the coatings industry (cf. Römpp Lexikon Lacke und Druckfarben, Georg Thieme Verlag, Stuttgart, New York, 1998, “automobile finishes”, pages 49 and 50).

In the context of the painting of automobiles, the pigmented coating materials may be used to produce primer-surfacer coats and antistonechip primer coats, solid-color topcoats and basecoats. The unpigmented materials are used to produce clearcoats.

The particularly high-quality coating systems of modern automobiles, especially those of the top class, nowadays comprise at least one primer-surfacer coat or antistonechip primer coat, at least one basecoat, and at least one clearcoat. This multicoat system is referred to here and below as a multicoat color and/or effect paint system.

Since the clearcoats form the outermost coat, they protect the underlying coats and emphasize the overall appearance of the multicoat color and/or effect paint system by intensifying the visual effect of the basecoat. In particular, the clearcoats are responsible for optical, mechanical, and chemical properties, such as gloss, distinctness of image (D.O.I.), hardness, scratch resistance, weathering stability, chemical stability, and etch resistance.

In order for the clearcoat materials, i.e., the unpigmented coating materials, to be able at all to give clearcoats having this profile of performance properties, they must on application and curing exhibit very good flow and a very low tendency to form runs, in order that the resulting clearcoat films are free from surface defects. In the course of curing, these films must not show any tendency to develop popping marks, pinholes, cracks or orange peel structures.

The existing solventborne clearcoat materials based on mixtures of aromatic hydrocarbons which are in commerce, for example, as the brands Solventnaphtha® or Solvesso® are able to a certain extent to meet these stringent requirements. In many cases, however, it is necessary to optimize the binders and/or crosslinking agents of the clearcoat materials in order to obtain an improvement. Nevertheless, such optimization is laborious and is in some cases accompanied by adverse interactions with the basecoat films or basecoats.

It is an object of the present invention to provide novel, solventborne, pigmented and unpigmented mixtures which are curable physically or thermally and/or with actinic radiation and which no longer have the disadvantages of the prior art but instead lend themselves outstandingly to use as pigmented and unpigmented coating materials, adhesives, and sealing compounds, especially pigmented and unpigmented coating materials, or to preparation of the same.

The pigmented coating materials, as primer-surfaces, solid-color topcoat materials or basecoat materials, are to be outstandingly suitable for the production of multicoat color and/or effect paint systems comprising primer-surfacer coats or antistonechip primer coats and solid-color topcoats or primer-surface coats or antistonechip primer coats, basecoats and clearcoats.

The unpigmented coating materials, as clearcoat materials, are to be outstandingly suitable above all for producing multicoat color and/or effect coating systems. In particular, the clearcoat materials are to be suitable for use in producing these multicoat color and/or effect paint systems by integrated wet-on-wet techniques in which at least one dried but not fully cured basecoat film is overcoated with a clearcoat film and then the two films are cured together.

On application and on curing, the primer-surfacers, solid-color topcoat materials, basecoat materials, and clearcoat materials, but especially the clearcoat materials, are to exhibit outstanding flow and outstanding running behavior, even on vertical surfaces, and are to develop defect-free coating films which surpass the films of the coating films of the prior art.

The resulting primer-surfacer coats or antistonechip primer coats, solid-color topcoats, basecoats, and clearcoats, but especially the clearcoats, are to have an outstanding defect-free surface without popping marks, pinholes, cracks or orange peel structures. The clearcoats in particular are to have a higher gloss, a greater distinctness of image (D.O.I.), and a better appearance than the clearcoats of the prior art. Moreover, the clearcoats are to match the prior art clearcoats in their hardness, scratch resistance, weathering stability, chemical stability, and etch resistance.

All this is to be possible without laborious variations and optimization of binders and/or crosslinking agents but instead by means of relatively simple measures which can be employed universally and are not limited to one system.

The invention accordingly provides for the novel use of an aromatic-free solvent mixture which consists of or comprises

(A) at least one low-boiling organic solvent and

(B) at least one organic solvent selected from the group consisting of high-boiling and middle-boiling organic solvents,

(1) at least one of the organic solvents (A) and/or (B) having a Hildebrand solubility parameter 8 (HSP) of between 10.5 and 12.0 (cal/cm³)^{1/2} and a hydrogen bonding index (HBI) between −15 and −20, and

(2) at least one of the organic solvents (A) and/or (B) having a Hildebrand solubility parameter δ (HSP) of between 8 and 9.7 (cal/cm³)^{1/2} and a hydrogen bonding index (HBI) between 0 and 12,

to improve the profile of properties of solventborne mixtures curable physically or thermally and/or with actinic radiation and of the products produced from them.

In the text below, the novel use of the aromatic-free solvent mixtures is referred to as “inventive use”.

The invention additionally provides the novel solventborne mixture curable physically or thermally and/or with actinic radiation, comprising an aromatic-free solvent mixture which consists of or comprises

(A) at least one low-boiling organic solvent and

(B) at least one organic solvent selected from the group consisting of high-boiling and middle-boiling organic solvents,

(1) at least one of the organic solvents (A) and/or (B) having a Hildebrand solubility parameter δ (HSP) of between 10.5 and 12.0 (cal/cm³)^{1/2} and a hydrogen bonding index (HBI) between −15 and −20, and

(2) at least one of the organic solvents (A) and/or (B) having a Hildebrand solubility parameter δ (HSP) of between 8 and 9.7 (cal/cm³)^{1/2} and a hydrogen bonding index (HBI) between 0 and 12.

In the text below, the novel solventborne mixture curable physically or thermally and/or with actinic radiation is referred to as the “mixture of the invention”.

Further subject matter of the invention will emerge from the description.

In the light of the prior art it was surprising and unforeseeable for the skilled worker that the object on which the present invention was based could be achieved by means of the inventive use. Even more of a surprise was that the aromatic-free solvent mixture for use in accordance with the invention was a complete replacement for the aromatic solvents commonly used. More surprising still was that this replacement led to a significant improvement in important performance properties, such as leveling and run resistance, of coating materials, adhesives, and sealing compounds curable physically or thermally and/or with actinic radiation.

Of particular surprise was that the inventive use was not limited to one system but was instead applicable almost universally in the field of solventborne mixtures curable physically or thermally and/or with actinic radiation.

A key surprise was that the coating materials, adhesives, and sealing compounds of the invention that comprised the aromatic-free solvent mixtures for use in accordance with the invention gave coatings, adhesive films, and seals having very good to outstanding performance properties. In particular, the coatings of the invention had outstanding defect-free surfaces without popping marks, pinholes, cracks or orange peel structures.

The clearcoats of the invention, especially, surprisingly manifested a higher gloss, a greater distinctness of image (D.O.I.), and a better appearance than the clearcoats of the prior art. Furthermore, the clearcoats of the invention fully matched the prior art clearcoats in their hardness, scratch resistance, weather stability, chemical stability, and etch resistance.

An overall surprise was that the inventive use offered the possibility of economically preparing and using toxicologically and environmentally unobjectionable mixtures of the invention which were substantially or entirely free from aromatic solvents.

Here and below, “aromatic-free” means that, in the aromatic-free solvent mixtures for use in accordance with the invention, the aromatic solvent content is less than 1.0% by weight, preferably less than 0.1% by weight, and in particular below the gas-chromatographic detection limit.

Here and below, “entirely free from aromatic solvents” means that the mixtures of the invention, based on their overall amounts, contain less than 1.0% by weight and in particular less than 0.1% by weight of aromatic solvents. In particular, the aromatic solvent content is below the gas-chromatographic detection limit. “Substantially free from aromatic solvents” means that, although the mixtures of the invention may contain a certain aromatic solvent content which, based on its overall amount, is >1.0% by weight, this content is not a result of the aromatic-free organic solvents for use in accordance with the invention but instead derives from aromatic solvents which are unavoidably “entrained” by the other constituents of the mixtures of the invention, such as binders or crosslinking agents.

Here and below, “actinic radiation” means electromagnetic radiation, such as near infrared (NIR), visible light, UV radiation, and X-rays, especially UV radiation, and corpuscular radiation, such as electron beams.

The Hildebrand solubility parameter δ (HSP) [(cal/cm³)^{1/2}] is defined in Römpp Lexikon Lacke und Druckfarben, Georg Thieme Verlag, Stuttgart, New York, 1998, “solubility parameters”, pages 361 to 365.

The hydrogen bonding index (HBI) describes the capacity of a solvent molecule to develop hydrogen bonds. Donors have a negative HBI and acceptors a positive HBI. The HBI is determined from the shift of the infrared band for RO-H stretching vibration. For the details, refer to the article by R. C. Nelson, R. W. Hemwall and G. D. Edwards, Journal of Paint Technology, “Treatment of Hydrogen Bonding in Predicting Miscibility”, volume 42, No. 550, November 1970, pages 636 to 643.

By “physical curing” is meant the curing of a layer of the mixture of the invention by filming, with linking within the coating taking place by looping of the polymer molecules of the binders (regarding the term, cf. Römpp Lexikon Lacke und Druckfarben, Georg Thieme Verlag, Stuttgart, New York, 1998, “binders”, pages 73 and 74). Or else filming takes place by the coalescence of binder particles (cf. Römpp Lexikon Lacke und Druckfarben, Georg Thieme Verlag, Stuttgart, New York, 1998, “curing”, pages 274 and 275). Normally, no crosslinking agents are required for this purpose. If desired, physical curing may be assisted by atmospheric oxygen, by heat, or by exposure to actinic radiation.

The mixtures of the invention may also be thermally curable. In this case they may be self-crosslinking or externally crosslinking.

The term “self-crosslinking” refers to the capacity of a binder to undergo crosslinking reactions with itself. A prerequisite for this is that the binders of the mixtures of the invention already contain both kinds of complementary reactive functional groups which are necessary for thermal crosslinking, or reactive functional groups which react “with themselves”. The term externally crosslinking, on the other hand, is used to refer to those mixtures of the invention in which one kind of the complementary reactive functional groups is present in the binder and the other kind is present in a curing or crosslinking agent. For further details, refer to Römpp Lexikon Lacke und Druckfarben, Georg Thieme Verlag, Stuttgart, New York, 1998, “curing”, pages 274 to 276, especially page 275, bottom.

The mixtures of the invention may be curable with actinic radiation. In this case curing takes place by way of groups containing bonds which can be activated with actinic radiation.

The mixtures of the invention may be curable thermally and with actinic radiation.

Where thermal curing and curing with actinic radiation are employed together for one mixture of the invention, the terms “dual cure” and “dual-cure mixture” are also used.

The mixtures of the invention may be one-component (1K) systems.

By one-component (1K) systems are meant mixtures of the invention which cure thermally, or thermally and with actinic radiation, and in which the binder and the crosslinking agent are present alongside one another. A prerequisite for this is that the two constituents undergo crosslinking with one another only at relatively high temperatures and/or on exposure to actinic radiation.

The mixtures of the invention may be two-component or multicomponent systems.

In these systems, the binders and the crosslinking agents are stored separately from one another, owing to their high reactivity, until shortly before the application of the mixtures of the invention.

The aromatic-free solvent mixture for use in accordance with the invention includes at least one, especially one, low-boiling organic solvent (A) and at least one organic solvent (B), especially two organic solvents (B), selected from the group consisting of high-boiling and middle-boiling organic solvents, or it consists of these organic solvents.

Accordingly, the aromatic-free solvent mixtures for use in accordance with the invention may comprise or consist of

low-boiling solvents (A) and high-boiling solvents (B),

low-boiling solvents (A) and middle-boiling solvents (B), and

low-boiling solvents (A) and middle-boiling and high-boiling solvents (B).

Preference is given to using low-boiling solvents (A) and middle-boiling solvents (B).

By low-boiling organic solvents (A) are meant, here and below, solvents which boil below 120° C. under atmospheric pressure.

By middle-boiling organic solvents (B) are meant, here and below, solvents which boil at between 120° C. and 190° C. under atmospheric pressure.

By high-boiling organic solvents (B) are meant, here and below, solvents which boil above 190° C. under atmospheric pressure.

The aromatic-free solvent mixture may further include nonaromatic organic solvents other than the organic solvents (A) and (B), in minor amounts. By minor amounts is meant a fraction <50, preferably <40, with particular preference <30, with very particular preference <20, and in particular <10% by weight, based in each case on the overall amount of the aromatic-free solvent mixture. This fraction merely varies the solvency properties of the aromatic-free solvent mixture, without decisively defining those properties. In accordance with the invention it is preferred for the aromatic-free solvent mixture to consist of the organic solvents (A) and (B).

The weight ratio of organic solvents (A) to organic solvents (B) may vary very widely and is guided in particular by the solubility properties of the other constituents of the mixtures of the invention and by the evaporation behavior that is required for trouble-free application and filming. The weight ratio (A):(B) is preferably from 1:15 to 2:1, more preferably from 1:10 to 1.5:1, with particular preference from 1:9 to 1.3:1, with very particular preference from 1:8 to 1.2:1, and in particular from 1:7 to 1.1:1.

For the aromatic-free solvent mixture it is important that

(1) at least one of the organic solvents (A) and/or. (B) having a Hildebrand solubility parameter δ (HSP) of between 10.5 and 12.0 (cal/cm³)^{1/2} and a hydrogen bonding index (HBI) between −15 and −20, and

(2) at least one of the organic solvents (A) and/or (B) having a Hildebrand solubility parameter δ (HSP) of between 8 and 9.7 (cal/cm³)^{1/2} and a hydrogen bonding index (HBI) between 0 and 12.

Preferably, the low-boiling organic solvents (A) have a Hildebrand solubility parameter δ (HSP) of between 10.5 and 12.0 (cal/cm³)^{1/2} and a hydrogen bonding index (HBI) of between −15 and −20.

Preferably, the middle-boiling and high-boiling organic solvents (B) have a Hildebrand solubility parameter δ (HSP) of between 8 and 9.7 (cal/cm³)^{1/2} and a hydrogen bonding index (HBI) of between 0 and 12.

Examples of highly suitable low-boiling organic solvents (A) (low boilers) are evident from compilation 1.

Compilation 1

| | Boiling point | | |
|---|---|---|---|
| | at atmospheric | | |
| Low boilers (A) | pressure (° C.) | HSP | HBI |
| n-Propanol | 96 | 11.9 | −16.5 |
| n-Butanol | 117-118 | 11.4 | −18 |
| Isobutanol | 108 | 10.7 | −17.9 |

Of these, n-butanol is used with preference.

Examples of highly suitable middle-boiling organic solvents (B) (middle boilers) are evident from compilation 2.

Compilation 2

| | Boiling point | | |
|---|---|---|---|
| | at atmospheric | | |
| Middle boilers (B) | pressure (° C.) | HSP | HBI |
| 1-Methoxypropanol | 117-125 | 9.5 | 0 |
| Glycolic acid butyl | 182 | — | — |
| ester (GB ester) | | | |
| Butyl acetate 98/100% | 113-126 | 8.6 | 8.3 |
| Pentyl acetate | 115-155 | 8.5 | 8.3 |
| Ethoxypropyl acetate (EPA) | 158 | — | — |
| 3-Methoxybutyl acetate | 171 | — | — |
| (Butoxyl ®) | | | |
| Ethyl ethoxypropionate (EEP) | 165 | 9.2 | 11.5 |
| Methyl amyl ketone (MAK) | 152 | 8.8 | 8.8 |

Of these, glycolic acid butyl ester (GB ester), butyl acetate 98/100%, ethoxypropyl acetate (EPA), ethyl ethoxypropionate (EEP) and methyl amyl ketone (MAK) are used with preference.

Examples of highly suitable high-boiling organic solvents (B) (high boilers) which meet the conditions specified above are evident from compilation 3.

Compilation 3

| | Boiling point | | |
|---|---|---|---|
| | at atmospheric | | |
| High boilers (B) | pressure (° C.) | HSP | HBI |
| Butyl diglycol | 197-205 | 8.9 | 0 |
| Isotridecyl alcohol (ITA) | 250-266 | — | — |
| Isononanol | — | — | — |
| Dibasic ester (DBE) | 196-255 | 9.2 | 8.5 |
| Butyl diglycol acetate | 235-250 | 8.5 | 9.0 |
| (BDGA) | | | |
| 2,4-Dimethyl-1,5-octanediol | 273 | — | — |
| (DEOD) | | | |

Of these, isotridecyl alcohol (ITA), dibasic ester (DBE), butyl diglycol acetate (BDGA), and 2,4-dimethyl-1,5-octanediol (DEOD) are used with preference.

Surprisingly, the inventive rule for selecting organic solvents (A) and (B) leads to aromatic-free solvent mixtures for use in accordance with the invention which not only are able fully to replace customary and known aromatic solvents and which, in replacement for the aromatic solvents, also significantly improve the profile of properties of the solventborne mixtures in question that are curable physically, thermally and/or with actinic radiation, and of the products produced from them, but are also substantially or entirely unobjectionable from a toxicological and environmental standpoint.

The amount of the aromatic-free solvent mixtures for use in accordance with the invention in the mixtures of the invention may vary very widely and is guided in particular by the solubility of the other constituents of the mixtures of the invention, by the viscosity required for processing, especially application, of the mixtures of the invention, and by the evaporation behavior that is to be formulated for a particular end use. Preferably, the amount of the aromatic-free solvent mixtures in the mixtures of the invention is from 5 to 95, more preferably from 6 to 90, with particular preference from 7 to 85, with very particular preference from 8 to 80, and in particular from 9 to 75% by weight, based in each case on the mixture of the invention.

The mixtures of the invention have an extraordinarily broad usefulness. With particular preference they are used as, or to prepare, coating materials, adhesives, and sealing compounds.

The coating materials, adhesives, and sealing compounds of the invention may be curable physically, thermally, with actinic radiation, and thermally and with actinic radiation (dual cure).

The mixtures of the invention, especially the coating materials, adhesives, and sealing compounds of the invention, may in addition to the aromatic-free solvent mixtures for use in accordance with the invention comprise, for example, the constituents described in detail in

the German patent application DE 199 24 171 A 1, page 5 line 47 to page 9 line 32,

the German patent DE 197 09 467 C 1, page 4 line 27 to page 6 line 30, or

the German patent application DE 199 20 799 A 1, page 3 line 58 to page 10 line 23.

The mixtures of the invention can in particular comprise binders and also, where appropriate, crosslinking agents and/or additives.

The binders are oligomeric and polymeric resins. By oligomers are meant resins containing at least 2 to 15 monomer units in their molecule. For the purposes of the present invention polymers are resins which contain at least 10 repeating monomer units in their molecule. For further details of these terms refer to Römpp Lexikon Lacke und Druckfarben, Georg Thieme Verlag, Stuttgart, New York, 1998, “Oligomers”, page 425.

Examples of suitable binders are random, alternating and/or block, linear and/or branched and/or comb addition (co)polymers of ethylenically unsaturated monomers, or polyaddition resins and/or polycondensation resins. For further details of these terms refer to Römpp Lexikon Lacke und Druckfarben, Georg Thieme Verlag, Stuttgart, New York, 1998, page 457, “Polyaddition” and “Polyaddition resins (polyadducts)”, and pages 463 and 464, “Polycondensates”, “Polycondensation”, and “Polycondensation resins”, and also pages 73 and 74, “Binders”.

In the context of the invention it is generally possible to use any of a wide variety of binders as principal binders. Those binders referred to as principal binders are binders which in terms of quantity constitute the greatest fraction of any other binders that may be used. Examples of suitable binders include optionally hydroxyl-containing polyacrylates, polyesters, polyurethanes, polyepoxides, and alkyd resins, oil-modified where appropriate.

In accordance with the invention, hydroxyl-containing polyacrylates or polyacrylate resins are of advantage and are therefore used with preference.

In one preferred embodiment the binder may be a polyacrylate resin which can be prepared by polymerizing (a) from 16 to 51% by weight, preferably from 16 to 28% by weight, of a hydroxyl-containing ester of acrylic acid or methacrylic acid or a mixture of such monomers, (b) from 32 to 84% by weight, preferably from 32 to 63% by weight, of a non-(a) aliphatic or cycloaliphatic ester of acrylic acid or methacrylic acid having preferably at least 4 carbon atoms in the alcohol residue, or a mixture of such monomers, (c) from 0 to 2% by weight, preferably from 0 to 1% by weight, of an ethylenically unsaturated carboxylic acid or a mixture of ethylenically unsaturated carboxylic acids, and (d) from 0 to 30% by weight, preferably from 0 to 20% by weight, of a non-(a), -(b), and -(c) ethylenically unsaturated monomer, or a mixture of such monomers, to give a polyacrylate resin having an acid number of from 0 to 25, preferably from 0 to 8, a hydroxyl number of from 80 to 200, preferably from 80 to 120, and a number-average molecular weight of from 1500 to 10000, preferably from 2000 to 5000, the sum of the weight fractions of components (a), (b), (c), and (d) always making 100% by weight.

The polyacrylate resins which are used with preference can be prepared by conventional polymerization techniques in bulk, solution or emulsion. Polymerization techniques for preparing polyacrylate resins are common knowledge and have been widely described (cf. e.g.: Houben Weyl, Methoden der organischen Chemie, 4th edition, volume 14/1, pages 24 to 255 (1961)).

Further examples of suitable (co)polymerization techniques for preparing the polyacrylate resins are described in patent DE-A-197 09 465, DE-C-197 09 476, DE-A-28 48 906, DE-A-195 24 182, EP-A-0 554 783, WO 95/27742, DE-A-38 41 540 or WO 82/02387.

Taylor reactors are advantageous, particularly for copolymerization in bulk, solution or emulsion.

The technique used to prepare the polyacrylate resins used is preferably that of solution polymerization. In this technique, normally, an organic solvent or solvent mixture is introduced and is heated to boiling. The monomer mixture to be polymerized, along with one or more polymerization initiators, is then added continuously to said organic solvent or solvent mixture. Polymerization takes place at temperatures between 100 and 160° C., preferably between 130 and 150° C. Polymerization initiators used are preferably free-radical initiators. The type and amount of initiator are commonly chosen so as to give a very largely constant supply of free radicals during the feed phase at the polymerization temperature.

Examples of initiators that may be used include the following: dialkyl peroxides, such as di-tert-butyl peroxide or dicumyl peroxide; hydroperoxides, such as cumene hydroperoxide or tert-butyl hydroperoxide; peresters, such as tert-butyl perbenzoate, tert-butyl perpivalate, tert-butyl per-3,5,5-trimethylhexanoate or tert-butyl per-2-ethylhexanoate; azo dinitriles such as azobisisobutyronitrile or C—C-cleaving initiators such as benzpinacol silyl ethers.

The polymerization conditions (reaction temperature, feed time of the monomer mixture, nature and amount of the organic solvents and polymerization initiators, possible use of molecular weight regulators, e.g., mercaptans, thioglycolates, and hydrogen chlorides) are selected so that the polyacrylate resins used have a number-average molecular weight from 1500 to 10000, preferably from 2000 to 5000 (determined by gel permeation chromatography using polystyrene as calibrating substance).

The acid number of the polyacrylate resins used may be adjusted by the skilled worker by using appropriate amounts of component (c). Similar comments apply to the adjustment of the hydroxyl number. It can be controlled by way of the amount of component (a) used.

As component (a) it is possible in principle to use any hydroxyl-containing ester of acrylic acid or methacrylic acid or a mixture of such monomers. Examples include the following: hydroxyalkyl esters of acrylic acid, such as hydroxyethyl acrylate, hydroxypropyl acrylate, hydroxybutyl acrylate, especially 4-hydroxybutyl acrylate; hydroxyalkyl esters of methacrylic acid, such as hydroxyethyl methacrylate, hydroxypropyl methacrylate, hydroxybutyl methacrylate, especially 4-hydroxybutyl methacrylate; reaction products of cyclic esters, such as ε-caprolactone, for example, and hydroxyalkyl esters of acrylic and/or methacrylic acid.

The composition of component (a) is preferably selected such that polymerization of component (a) alone gives a polyacrylate resin having a glass transition temperature of from −50 to +70° C., preferably from −30 to +50° C. The glass transition temperature may be calculated approximately by the skilled worker with the aid of the formula

n=x

1/T_{g}=ΣWₙ/T_{gn}

n=1

T_{g}=glass transition temperature of the polymer

x=number of different copolymerized monomers

Wₙ=weight fraction of the nth monomer

T_{gn}32 glass transition temperature of the homopolymer of the nth monomer.

As component (b) it is possible in principle to use any non-(a) aliphatic or cycloaliphatic ester of acrylic or methacrylic acid having at least 4 carbon atoms in the alcohol residue, or a mixture of such monomers. Examples include the following: aliphatic esters of acrylic and methacrylic acid having from 4 to 20 carbon atoms in the alcohol residue, such as n-butyl, isobutyl, tert-butyl, 2-ethylhexyl, stearyl and lauryl acrylate and methacrylate, and also cycloaliphatic esters of acrylic acid and methacrylic acid, such as cyclohexyl acrylate and cyclohexyl methacrylate, for example. The composition of component (b) is preferably selected so that polymerization of component (b) alone gives a polyacrylate resin having a glass transition temperature of from 10 to 100° C., preferably from 20 to 60° C.

As component (c) it is possible in principle to use any ethylenically unsaturated carboxylic acid or a mixture of ethylenically unsaturated carboxylic acids. As component (c) it is preferred to use acrylic acid and/or methacrylic acid.

As component (d) it is possible in principle to use any non-(a), -(b), and -(c) ethylenically unsaturated monomer or a mixture of such monomers. Examples of monomers which can be used as component (d) include the following: vinylaromatic hydrocarbons, such as styrene, alpha-alkylstyrene, and vinyltoluene, amides of acrylic acid and methacrylic acid, such as methacrylamide and acrylamide, nitrites of methacrylic acid and acrylic acid; vinyl ethers and vinyl esters or polysiloxane macromonomers, as described in patent DE-A-38 07 571, DE-A-37 06 095, EP-B-0 358 153, U.S. Pat. No. 4,754,014, DE-A-44 21 823 or WO 92/22615. As component (d) it is preferred to use vinylaromatic hydrocarbons, especially styrene. The composition of component (d) is preferably selected so that polymerization of component (d) alone gives a resin having a glass transition temperature of from 70 to 120° C., preferably from 80 to 100° C.

In the coating material the binders are present advantageously in an amount of from 10 to 90% by weight, with particular preference from 15 to 80% by weight, and in particular from 20 to 70% by weight, based on each case on the overall solids content of the coating material.

Examples of suitable addition (co)polymers are (meth)acrylate (co)polymers or partially hydrolyzed polyvinyl esters, especially (meth)acrylate copolymers.

Examples of suitable polyaddition resins and/or polycondensation resins are polyesters, alkyds, polyurethanes, polylactones, polycarbonates, polyethers, epoxy resin-amine adducts, polyureas, polyamides, polyimides, polyester-polyurethanes, polyether-polyurethanes or polyester-polyether-polyurethanes, especially polyester-polyurethanes.

Of these binders, the (meth)acrylate (co)polymers have particular advantages and are therefore used with special preference.

The self-crosslinking binders comprise reactive functional groups which are able to enter into crosslinking reactions with groups of their type or with complementary reactive functional groups. The externally crosslinking binders comprise reactive functional groups which are able to enter into crosslinking reactions with complementary reactive functional groups present in crosslinking agents. Examples of suitable complementary reactive functional groups for use in accordance with the invention are summarized in the following overview. In the overview, the variable R is an acyclic or cyclic aliphatic, an aromatic, and/or an aromatic-aliphatic (araliphatic) radical; the variables R′ and R″ are identical or different aliphatic radicals or are linked to one another to form an aliphatic or heteroaliphatic ring.

Overview: Examples of Complementary Functional Groups

| Binder | and | crosslinking agent |
|---|---|---|
| | or | |
| Crosslinking agent | and | binder |
| —SH | | —C(O)—OH |
| —NH₂ | | —C(O)—O—C(O)— |
| —OH | | —NCO |
| —O—(CO)—NH—(CO)—NH₂ | | —NH—C(O)—OR |
| —O—(CO)—NH₂ | | —CH₂—OH |
| >NH | | —CH₂—O—R |
| | | —NH—CH₂—O—R |
| | | —NH—CH₂—OH |
| | | —N(—CH₂—O—R)₂ |
| | | —NH—C(O)—CH(—C(O)OR)₂ |
| | | —NH—C(O)—CH(—C(O)OR) |
| | | (—C(O)—R) |
| | | —NH—C(O)—NR′R″ |
| | | >Si(OR)₂ |
| | | O |
| | | —CH—CH₂ |
| | | O |
| | | C |
| | | O O |
| | | —CH—CH₂ |
| | | O |
| —C(O)—OH | | —CH—CH₂ |
| | | —C(O)—N(CH₂—CH₂—OH)₂ |

The selection of the complementary groups in each case is guided firstly by the fact that during the preparation, storage and application they should not enter into any unwanted reactions, in particular any premature crosslinking, and/or, if appropriate, should not disrupt or inhibit curing with actinic radiation, and secondly by the temperature range within which crosslinking is to take place.

Use is therefore made preferably of thio, hydroxyl, N-methylolamino, N-alkoxymethylamino, imino, carbamate, allophanate and/or carboxyl groups, preferably hydroxyl or carboxyl groups, on the one hand, and preferably crosslinking agents containing anhydride, carboxyl, epoxy, blocked isocyanate, urethane, methylol, methylol ether, siloxane, carbonate, amino, hydroxyl and/or beta-hydroxyalkylamide groups, preferably epoxy, beta-hydroxyalkylamide, blocked isocyanate, urethane or alkoxymethylamino groups, on the other.

Self-crosslinking binders contain in particular methylol, methylol ether, and/or N-alkoxymethylamino groups.

Complementary reactive functional groups especially preferred are

hydroxyl groups on the one hand and blocked isocyanate, urethane or alkoxymethylamino groups on the other.

The functionality of the binders in respect of the reactive functional groups described above may vary very widely and depends in particular on the desired crosslinking density and/or on the functionality of the crosslinking agents employed in each case. In the case of hydroxyl-containing binders, the OH number, in contradistinction to the above indications, can for a preferred binder also be from 15 to 300, preferably from 30 to 250, with particular preference from 50 to 200, with very particular preference from 70 to 180, and in particular from 80 to 170 mg KOH/g.

The complementary functional groups described above can be incorporated into the binders in accordance with the customary and known methods of polymer chemistry. This can be done, for example, by incorporating monomers which carry the corresponding reactive functional groups, and/or with the aid of polymer-analogous reactions.

A more comprehensive—as compared with the above illustration in relation to the acrylate resins—compilation of examples of suitable olefinically unsaturated monomers containing reactive functional groups is as follows:

a1) monomers which carry at least one hydroxyl, amino, alkoxymethylamino, carbamate, allophanate or imino group per molecule, such as

hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleate, fumarate or itaconate; or hydroxycycloalkyl esters such as 1,4-bis(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; reaction products of cyclic esters, such as epsilon-caprolactone and these hydroxyalkyl or hydroxycycloalkyl esters;

olefinically unsaturated alcohols such as allyl alcohol;

polyols such as trimethylolpropane monoallyl or diallyl ether or pentaerythritol monoallyl, diallyl or triallyl ether;

reaction products of acrylic acid and/or methacrylic acid with the glycidyl ester of an alpha-branched monocarboxylic acid having 5 to 18 carbon atoms per molecule, especially a Versatic® acid, or instead of the reaction product an equivalent amount of acrylic and/or methacrylic acid, which is then reacted during or after the polymerization reaction with the glycidyl ester of an alpha-branched monocarboxylic acid having 5 to 18 carbon atoms per molecule, especially a Versatic® acid;

aminoethyl acrylate, aminoethyl methacrylate, allylamine or N-methyliminoethyl acrylate;

N,N-di(methoxymethyl)aminoethyl acrylate or methacrylate or N,N-di(butoxymethyl) aminopropyl acrylate or methacrylate;

(meth)acrylamides such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)-(meth)acrylamide;

acryloyloxy- or methacryloyloxyethyl, -propyl or -butyl carbamate or allophanate; further examples of suitable monomers containing carbamate groups are described in the patents U.S. Pat. No. 3,479,328 A, U.S. Pat. No. 3,674,838 A, U.S. Pat. No. 4,126,747 A, U.S. Pat. No. 4,279,833 A or U.S. Pat. No. 4,340,497 A;

a2) monomers which carry at least one acid group per molecule, such as

acrylic acid, methacrylic acid, ethacrylic acid, crotonic acid, maleic acid, fumaric acid or itaconic acid;

olefinically unsaturated sulfonic or phosphonic acids or their partial esters;

mono(meth)acryloyloxyethyl maleate, succinate or phthalate; or

vinylbenzoic acid (all isomers), alpha-methylvinylbenzoic acid (all isomers) or vinylbenzenesulfonic acid (all isomers);

a3) monomers containing epoxide groups, such as the glycidyl ester of acrylic acid, methacrylic acid, ethacrylic acid, crotonic acid, maleic acid, fumaric acid or itaconic acid, or allyl glycidyl ether.

They are preferably used to prepare the inventively preferred (meth)acrylate copolymers, especially ones containing hydroxyl and/or carbamate groups.

More highly functional monomers of the type described above are generally used in minor amounts. For the purposes of the present invention, minor amounts of higher-functional monomers are those amounts which do not lead to crosslinking or gelling of the addition copolymers, in particular of the (meth)acrylate copolymers, unless the specific desire is to prepare crosslinked polymeric microparticles.

Examples of suitable monomer units for introducing reactive functional groups into polyesters or polyester-polyurethanes are 2,2-dimethylolethyl- or -propylamine blocked with a ketone, the resulting ketoxime group being hydrolyzed again following incorporation; or compounds containing two hydroxyl groups or two primary and/or secondary amino groups and also at least one acid group, in particular at least one carboxyl group and/or at least one sulfonic acid group, such as dihydroxypropionic acid, dihydroxysuccinic acid, dihydroxybenzoic acid, 2,2-dimethylolacetic acid, 2,2-dimethylolpropionic acid, 2,2-dimethylolbutyric acid, 2,2-dimenthylolpentanoic acid, alpha-omega###-diaminovaleric acid, 3,4-diaminobenzoic acid, 2,4-diaminotoluenesulfonic acid or 2,4-diaminodiphenyl ether sulfonic acid.

One example of introducing reactive functional groups by way of polymer-analogous reactions is the reaction of hydroxyl-containing resins with phosgene, resulting in resins containing chloroformate groups, and the polymer-analogous reaction of the chloroformate-functional resins with ammonia and/or primary and/or secondary amines to give resins containing carbamate groups. Further examples of suitable methods of this kind are known from the patents U.S. Pat. No. 4,758,632 A1, U.S. Pat. No. 4,301,257 A1 or U.S. Pat. No. 2,979,514 A1.

The binders of the dual-cure mixtures of the invention further comprise on average at least one, preferably at least two, group(s) having per molecule at least one bond that can be activated with actinic radiation.

For the purposes of the present invention, a bond that can be activated with actinic radiation is a bond which on exposure to actinic radiation becomes reactive and, with other activated bonds of its kind, enters into addition polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as double bonds.

Accordingly, the group which is preferred in accordance with the invention comprises one double bond or two, three or four double bonds. If more than one double bond is used, the double bonds can be conjugated. In accordance with the invention, however, it is of advantage if the double bonds are present in isolation, in particular each being present terminally, in the group in question. It is of particular advantage in accordance with the invention to use two double bonds or, in particular, one double bond.

The dual-cure binder contains on average at least one of the above-described groups that can be activated with actinic radiation. This means that the functionality of the binder in this respect is integral, i.e., for example, is two, three, four, five or more, or nonintegral, i.e., for example, is from 2.1 to 10.5 or more. The functionality chosen depends on the requirements imposed on the respective coating composition.

If more than one group that can be activated with actinic radiation is used on average per molecule, the groups are structurally different from one another or of the same structure.

If they are structurally different from one another, this means, in the context of the present invention, that use is made of two, three, four or more, but especially two, groups that can be activated by actinic radiation, these groups deriving from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, but especially acrylate groups.

Preferably, the groups are attached to the respective parent structures of the binders via urethane, urea, allophanate, ester, ether and/or amide groups, but in particular via ester groups. Normally, this occurs as a result of customary and known polymer-analogous reactions such as, for instance, the reaction of pendant glycidyl groups with the olefinically unsaturated monomers described above that contain an acid group, of pendant hydroxyl groups with the halides of these monomers, of hydroxyl groups with isocyanates containing double bonds such as vinyl isocyanate, methacryloyl isocyanate and/or 1-(1-isocyanato-1-methylethyl)-3-(1-methylethenyl)benzene (TMI® from the company CYTEC), or of isocyanate groups with the above-described hydroxyl-containing monomers.

Alternatively it is possible to employ mixtures of purely thermally curable binders and binders that are curable purely with actinic radiation.

Examples of suitable binders curable solely with actinic radiation come from the oligomer and/or polymer classes of the (meth)acryloyl-functional (meth)acrylic copolymers, polyether acrylates, polyester acrylates, polyesters, epoxy acrylates, urethane acrylates, amino acrylates, melamine acrylates, silicone acrylates and phosphazene acrylates and the corresponding. methacrylates. It is preferred to use binders (a1) which are free from aromatic structural units. Preference is therefore given to the use of urethane (meth)acrylates, phosphazene (meth)acrylates and/or polyester (meth)-acrylates, with particular preference urethane (meth)acrylates, especially aliphatic urethane (meth)acrylates.

The urethane (meth)acrylates are obtained by reacting a diisocyanate or polyisocyanate with a chain extender from the group of the diols/polyols and/or diamines/polyamines and/or dithiols/polythiols and/or alkanolamines and subsequently reacting the remaining free isocyanate groups with at least one hydroxyalkyl (meth)acrylate or hydroxyalkyl ester of other ethylenically unsaturated carboxylic acids.

The amounts of chain extender, diisocyanate and/or polyisocyanate and hydroxyalkyl ester are in this case preferably chosen so that

1.) the ratio of equivalents of the NCO groups to the reactive groups of the chain extender (hydroxyl, amino and/or mercaptyl groups) is between 3:1 and 1:2, being preferably 2:1, and

2.) the OH groups of the hydroxyalkyl esters of the ethylenically unsaturated carboxylic acids are present in stoichiometric amount in relation to the remaining free isocyanate groups of the prepolymer formed from isocyanate and chain extender.

It is also possible to prepare the urethane (meth)acrylates by first reacting some of the isocyanate groups with a diisocyanate or polyisocyanate with at least one hydroxyalkyl ester and then reacting the remaining isocyanate groups with a chain extender.

In this case as well the amounts of chain extender, isocyanate and hydroxyalkyl ester are chosen so that the ratio of equivalents of the NCO groups to the reactive groups of the chain extender is between 3:1 and 1:2, preferably 2:1, and the ratio of equivalents of the remaining NCO groups to the OH groups of the hydroxyalkyl ester is 1:1. Of course, all intermediate forms between these two processes are also possible. For example, some of the isocyanate groups of a diisocyanate may first be reacted with a diol, after which a further portion of the isocyanate groups may be reacted with the hydroxyalkyl ester, and, subsequently, the remaining isocyanate groups may be reacted with a diamine.

These various preparation processes of the urethane (meth)acrylates are known from, for example the patent EP 0 204 16 A 1.

Flexibilization of the urethane (meth)acrylates is possible, for example, by reacting corresponding isocyanate-functional prepolymers or oligomers with relatively long-chain aliphatic diols and/or diamines, especially aliphatic diols and/or diamines having at least 6 carbon atoms. This flexibilization reaction may be carried out before or after the addition of acrylic or methacrylic acid onto the oligomers or prepolymers.

Examples of suitable urethane (meth)acrylates that may be mentioned include the following, commercially available, polyfunctional aliphatic urethane acrylates:

Crodamer® UVU 300 from Croda Resins Ltd, Kent, United Kingdom;

Genomer® 4302, 4235, 4297 or 4316 from Rahn Chemie, Switzerland;

Ebecryl® 284, 294, IRR351, 5129 or 1290 from UCB, Drogenbos, Belgium;

Roskydal® LS 2989 or LS 2545 or V94-504 from Bayer AG, Germany;

Viaktin® VTE 6160 from Vianova, Austria; and

Laromer® 8861 from BASF AG, and experimental products derived therefrom by modification.

An example of a suitable phosphazene (meth)acrylate is the phosphazene dimethacrylate from Idemitsu, Japan.

Examples of suitable preparation processes for (meth)acrylate copolymers are described in European Patent Application EP 0 767 185 A1, in German Patents DE 22 14 650 B1 or DE 27 49 576 B1, and in U.S. Pat. Nos. 4,091,048 A1, 3,781,379 A1, 5,480,493 A1, 5,475,073 A1 or 5,534,598 A1, or in the standard work Houben-Weyl, Methoden der organischen Chemie, 4^{th} Edition, Volume 14/1, pages 24 to 255, 1961. Suitable reactors for the copolymerization are the customary and known stirred vessels, cascades of stirred vessels, tube reactors, loop reactors or Taylor reactors, as described, for example, in the patents and patent applications DE 1 071 241 B1, EP 0 498 583 A1 or DE 198 28 742 A1 or in the article by K. Kataoka in Chemical Engineering Science, Volume 50, No. 9, 1995, pages 1409 to 1416.

The preparation of polyesters and alkyd resins is also described, for example, in the standard work Ullmanns Encyklopädie der technischen Chemie, 3^{rd} Edition, Volume 14, Urban & Schwarzenberg, Munich, Berlin, 1963, pages 80 to 89 and pages 99 to 105, and also in the following books: “Résines Alkydes-Polyesters” by J. Bourry, Paris, Dunod, 1952, “Alkyd Resins” by C. R. Martens, Reinhold Publishing Corporation, New York, 1961, and “Alkyd Resin Technology” by T. C. Patton, Interscience Publishers, 1962.

The preparation of polyurethanes and/or acrylated polyurethanes is also described, for example, in the patent applications EP 0 708 788 A1, DE 44 01 544 A1 or DE 195 34 361 A1.

Examples of suitable crosslinking agents are

amino resins, as described for example in Römpp Lexikon Lacke und Druckfarben, Georg Thieme Verlag, 1998, page 29, “Amino resins”, in the textbook “Lackadditive” [Coatings additives] by Johan Bieleman, Wiley-VCH, Weinheim, New York, 1998, pages 242 ff., in the book “Paints, Coatings and Solvents”, second, completely revised edition, eds. D. Stoye and W. Freitag, Wiley-VCH, Weinheim, New York, 1998, pages 80 ff., in patents U.S. Pat. No. 4,710,542 A1 or EP 0 245 700 A1, and in the article by B. Singh and coworkers “Carbamyl-methylated Melamines, Novel Crosslinkers for the Coatings Industry” in Advanced Organic Coatings Science and Technology Series, 1991, Volume 13, pages 193 to 207. In this context it is possible to use any amino resins suitable for transparent topcoat or clearcoat materials, or a mixture of such amino resins. Particularly suitable are the conventional amino resins some of whose methylol and/or methoxymethyl groups have been defunctionalized by means of carbamate or allophanate groups.

Carboxyl-containing compounds or resins, as described for example in the patent DE 196 52 813 A1 or 198 41 408 A1, especially dodecanedioic acid;

epoxy-containing compounds or resins, as described for example in patents EP 0 299 420 A1, DE 22 14 650 B1, DE 27 49 576 B1, U.S. Pat. No. 4,091,048 A1 or U.S. Pat. No. 3,781,379 A1;

blocked and non-blocked polyisocyanates, as described for example in the patents U.S. Pat. No. 4,444,954 A1, DE 196 17 086 A1, DE 196 31 269 A1, EP 0 004 571 A1 or EP 0 582 051 A1, especially what are called paint polyisocyanates, having free isocyanate groups attached aliphatically, cycloaliphatically, araliphatically and/or aromatically. Preference is given to using polyisocyanates having 2 to 5 isocyanate groups per molecule and having viscosities of from 100 to 10 000, preferably from 100 to 5 000, and in particular from 100 to 2 000 mPas (at 23° C.). If desired, small amounts of organic solvent, preferably from 1 to 25% by weight based on straight polyisocyanate, can be added to the polyisocyanates in order to enhance the ease of incorporation of the isocyanate and, where appropriate, to lower the viscosity of the polyisocyanate to a level within the abovementioned ranges. Solvents suitable as additions to the polyisocyanates are, for example, ethoxyethyl propionate, amyl methyl ketone or butyl acetate. In addition, the polyisocyanates may have undergone conventional hydrophilic or hydrophobic modification.

Also suitable, for example, are the isocyanate-containing polyurethane prepolymers which can be prepared by reacting polyols with an excess of polyisocyanates and which are preferably of low viscosity.

Further examples of suitable polyisocyanates are polyisocyanates containing isocyanurate, biuret, allophanate, iminooxadiazinedione, urethane, urea and/or uretdione groups. Polyisocyanates containing urethane groups, for example, are obtained by reacting some of the isocyanate groups with polyols, such as trimethylolpropane and glycerol, for example. Preference is given to using aliphatic or cycloaliphatic polyisocyanates, especially hexamethylene diisocyanate, dimerized and trimerized hexamethylene diisocyanate, isophorone diisocyanate, 2-isocyanatopropylcyclohexyl isocyanate, dicyclohexylmethane 2,4′-diisocyanate or dicyclohexylmethane 4,4′-diisocyanate, diisocyanates derived from dimer fatty acids, as sold under the trade name DDI 1410 by Henkel, 1,8-diisocyanato-4-isocyanatomethyloctane, 1,7-diisocyanato-4-isocyanatomethylheptane or 1-isocyanato-2-(3-isocyanatopropyl)cyclohexane or mixtures of these polyisocyanates.

Further examples of suitable isocyanates are described in “Methoden der organischen Chemie”, Houben-Weyl, Volume 14/2, 4th edition, Georg Thieme Verlag, Stuttgart 1963, page 61 to 70, W. Siefken, Liebigs Ann. Chem. 562, 75 to 136, European patent EP-A-101 832 or U.S. patents U.S. Pat. No. 3,290,350, U.S. Pat. No. 4,130,577, and U.S. Pat. No. 4,439,616. Examples of suitable blocking agents are the blocking agents known from U.S. Pat. No. 4,444,954.

beta-hydroxyalkylamides such as N,N,N′,N′-tetrakis(2-hydroxyethyl)adipamide or N,N,N′,N′-tetrakis(2-hydroxypropyl)adipamide; and/or

tris(alkoxycarbonylamino)triazines, as described in patents U.S. Pat. No. 4,939,213 A1, U.S. Pat. No. 5,084,541 A1, U.S. Pat. No. 5,288,865 A1 or EP 0 604 922 A1, or in EP 0 624 577, or tris(alkoxycarbonylamino)-triazines of the general formula

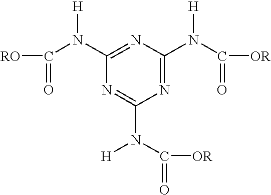

Use can be made in particular of the tris(methoxy-, tris(butoxy- and/or tris(2-ethyl-hexoxycarbonylamino)triazines.

Of advantage are the methyl butyl mixed esters, butyl 2-ethylhexyl mixed esters, and the butyl esters. They have the advantage over the straight methyl ester of better solubility in polymer melts, and also have less of a tendency to crystallize out.

beta-hydroxyalkylamides such as N,N,N′,N′-tetrakis(2-hydroxyethyl)adipamide or N,N,N′,N′-tetrakis(2-hydroxypropyl)adipamide;

siloxanes, particularly siloxanes having at least one trialkoxysilane or dialkoxysilane group,

polyanhydrides, especially polysuccinic anhydride.

Examples of suitable additives are in particular

thermally curable reactive diluents such as positionally isomeric diethyloctanediols or hydroxyl-containing hyperbranched compounds or dendrimers;

reactive diluents curable with actinic radiation, such as those described in Römpp Lexikon Lacke und Druckfarben, Georg Thieme Verlag, Stuttgart, New York, 1998 on page 491 under the headword “Reactive diluents”; examples are (meth)acrylic acid and esters thereof, maleic acid and its esters and/or mono esters, vinyl acetate, vinyl ethers, vinylureas, and the like. Examples that may be mentioned include alkylene glycol di(meth)acrylate, polyethylene glycol di(meth)acrylate, 1,3-butanediol di(meth)acrylate, vinyl (meth)acrylate, allyl (meth)acrylate, glyceryl tri(meth)acrylate, trimethylolpropane tri(meth)acrylate, trimethylolpropane di(meth)acrylate, styrene, vinyltoluene, divinylbenzene, pentaerythrityl tri(meth)acrylate, pentaerythrityl tetra(meth)acrylate, dipropylene glycol di(meth)acrylate, hexanediol di(meth)acrylate, ethoxy-ethoxyethyl acrylate, N-vinylpyrrolidone, phenoxyethyl acrylate, dimethylaminoethyl acrylate, hydroxyethyl (meth)acrylate, butoxyethyl acrylate, isobornyl (meth)acrylate, dimethylacrylamide and dicyclopentyl acrylate, the long-chain linear diacrylates described in EP 0 250 631 A1 with a molecular weight of from 400 to 4000, preferably from 600 to 2500. The two acrylate groups may for example be separated by a polyoxybutylene structure. Also suitable for use are 1,12-dodecyl diacrylate and the reaction product of 2 moles of acrylic acid with one mole of a dimer fatty alcohol having generally 36 carbon atoms. Mixtures of said monomers are also suitable;

crosslinking catalysts such as dibutyltin dilaurate, lithium decanoate or zinc octoate, amine-blocked organic sulfonic acids, quaternary ammonium compounds, amines, imidazole and imidazole derivatives such as 2-styrylimidazole, 1-benzyl-2-methylimidazole, 2-methylimidazole and 2-butylimidazole, as described in Belgian Patent No. 756,693, or phosphonium catalysts such as ethyltriphenylphosphonium iodide, ethyltriphenylphosphonium chloride, ethyltriphenylphosphonium thiocyanate, ethyltriphenylphosphonium acetate-acetic acid complex, tetrabutylphosphonium iodide, tetrabutylphosphonium bromide and tetrabutylphosphonium acetate-acetic acid complex, as are described, for example, in U.S. Pat. Nos. 3,477,990 A1 or 3,341,580 A1;

thermally labile free-radical initiators such as organic peroxides, organic azo compounds or C—C-cleaving initiators such as dialkyl peroxides, peroxocarboxylic acids, peroxodicarbonates, peroxide esters, hydroperoxides, ketone peroxides, azodinitriles or benzpinacol silyl ethers;

photoinitiators, as described in Römpp Chemie Lexikon, 9^{th}, expanded and revised edition, Georg Thieme Verlag, Stuttgart, Vol. 4, 1991, or in Römpp Lexikon Lacke und Druckfarben, Georg Thieme Verlag, Stuttgart, 1998, pages 444 to 446;

antioxidants such as hydrazines and phosphorus compounds;

UV absorbers such as triazines and benzotriphenol;

light stabilizers such as HALS compounds, benzotriazoles or oxalanilides;

leveling agents;

free-radical scavengers and polymerization inhibitors such as organic phosphites or 2,6-di-tert-butylphenol derivatives;

slip additives;

defoamers;

wetting agents such as siloxanes, fluorine compounds, carboxylic monoesters, phosphoric esters, polyacrylic acids and their copolymers, or polyurethanes, as described, for example, in detail in patent application DE 198 35 296 A1, especially in conjunction with the polyurethane-based associative thickeners described below;

adhesion promoters such as tricyclodecanedimethanol;

film-forming auxiliaries such as cellulose derivatives;

flame retardants;

devolatilizers such as diazadicycloundecane or benzoin;

rheology control additives (thickeners), such as those known from patent applications WO 94/22968, EP 0 276 501 A1, EP 0 249 201 A1 or WO 97/12945; crosslinked polymeric microparticles, such as those disclosed, for example, in EP-A-0 008 127; inorganic sheet silicates such as aluminum-magnesium silicates, sodium-magnesium and sodium-magnesium-fluorine-lithium sheet silicates of the montmorillonite type; silicas such as Aerosils; or synthetic polymers having ionic and/or associative groups, such as polyvinyl alcohol, poly(meth)acrylamide, poly(meth)acrylic acid, polyvinyl-pyrrolidone, styrene-maleic anhydride copolymers or ethylene-maleic anhydride copolymers and their derivatives or polyacrylates; or polyurethane-based associative thickeners, as described in Römpp Lexikon Lacke und Druckfarben, Georg Thieme Verlag, Stuttgart, New York, 1998, “Thickeners”, pages 599 to 600, and in the textbook “Lackadditive” by Johan Bieleman, Wiley-VCH, Weinheim, New York, 1998, pages 51 to 59 and 65;

Further examples of suitable additives are described in the textbook “Lackadditive” by Johan Bieleman, Wiley-VCH, Weinheim, New York, 1998.

The constituents are preferably selected such that the cured mixtures of the invention have a storage modulus E′ in the rubber-elastic range of at least 10^{7.6} Pa and a loss factor tanδ at 20° C. of not more than 0.10, the storage modulus E′ and the loss factor having been measured by dynamic mechanical thermo analysis on free films having a thickness of 40±10 μm.

The coating materials, adhesives, and sealing compounds may be prepared by the processes described in

the German patent application DE 199 24 171 A 1, page 9 lines 33 to 54, or

the German patent application DE 199 20 799 A 1.

Examples of suitable substrates and application techniques are described in

the German patent application DE 199 24 171 A 1, page 9 line 55 to page 10 line 23, or

the German patent application DE 199 20 799 A 1, page 3 lines 41 to 58 and page 10 lines 38 to 65.

Examples of suitable methods of thermal curing and of curing with actinic radiation are known, for example, from

the International patent application WO 98/40170, page 17 line 18 to page 29 line 20,

the German patent application DE 199 20 799 A1, page 10 line 66 to page 11 line 41, or

the German patent application DE 198 18 713 A 1, column 10 line 31 to column 11 line 33.

The coating materials of the invention are used in particular as clearcoat materials and/or as color and/or effect coating materials for the production of clearcoats and also single-coat and/or multicoat, color and/or effect, electrically conductive, magnetically shielding and/or fluorescent coatings.

The stability of the coating materials, adhesives, and sealing compounds of the invention under static and dynamic conditions, especially the circulation stability, and also the running behavior on application and curing, are outstanding.

Accordingly, the coating materials, adhesives, and sealing compounds of the invention are outstandingly suitable for the coating, adhesive bonding, and sealing of motor vehicle bodies, parts of motor vehicle bodies, the inside and outside of motor vehicles, the inside and outside of buildings, doors, windows and furniture, and also for coating, adhesive bonding, and sealing in the context of the industrial coating for example of small parts, such as nuts, bolts, wheel rims or hubcaps, coils, containers, packaging, electrical components, such as motor windings or transformer windings, and of white goods, such as domestic appliances, boilers, and radiators.

The coatings of the invention produced from the coating materials of the invention are hard, scratch-resistant, weathering-stable, chemically stable, and in particular of an extraordinarily high brightness.

The adhesive films produced from the adhesives of the invention generally bond with a very wide variety of substrates bonded using them. Even under extreme climatic conditions and/or highly fluctuating temperatures, there is no loss of bond strength.

The seals produced from the sealing compounds of the invention durably seal the substrates sealed using them, even in the presence of strongly aggressive chemicals.

Accordingly, the substrates coated with the coatings of the invention, the substrates adhesively bonded with the adhesive films of the invention, and/or the substrates sealed with the seals of the invention are of an extraordinarily long service life and of a particularly high utility, which makes them particularly economic in production and use.

### INVENTIVE EXAMPLES 1 TO 4 AND COMPARATIVE EXAMPLE C1

### The Preparation of the Inventive Clearcoat Materials and Clearcoats (Inventive Examples 1 to 4) and of a Noninventive Clearcoat Material and of a Noninventive Clearcoat (Comparative Example C1)

The inventive clearcoat materials 1 to 4 and the non-inventive clearcoat material C1 were prepared by mixing the constituents indicated in table 1 and homogenizing the resulting mixtures.

TABLE 1
The material composition of the inventive
clearcoat materials 1 to 4 and of the non-
inventive clearcoat material C1

| | Examples: | | | | |
|---|---|---|---|---|---|
| | 1 | 2 | 3 | 4 | C1 |
| Constituent | (parts by weight) | | | | (comparative) |
| Binder^{a)} | 46 | 46 | 46 | 46 | 46 |
| Crosslinking agent: | | | | | |
| Melamine resin, | 15.6 | 15.6 | 15.6 | 15.6 | 15.6 |
| Luwipal ® 018 | | | | | |
| (BASF AG), solids: | | | | | |
| Rheological agent: | | | | | |
| Urea derivative | 17.7 | 17.7 | 17.7 | 17.7 | 17.7 |
| dispersion, Setalux ® | | | | | |
| C91756 (Akzo) | | | | | |
| Catalyst: | | | | | |
| Blocked sulfonic acid | 1 | 1 | 1 | 1 | 1 |
| Nacure ® 2500 (King) | | | | | |
| Additives: | | | | | |
| BYK ® 390 | 0.3 | 0.3 | 0.3 | 0.3 | 0.3 |
| BYK ® 325 | 0.2 | 0.2 | 0.2 | 0.2 | 0.2 |
| (Byk Chemie) | | | | | |
| Light stabilizers: | | | | | |
| Tinuvin ® 384-2 | 0.7 | 0.7 | 0.7 | 0.7 | 0.7 |
| Tinuvin ® 292 | 0.6 | 0.6 | 0.6 | 0.6 | 0.6 |
| (Ciba Specialty | | | | | |
| Chemicals) | | | | | |
| Aromatic solvents: | | | | | |
| (added, not | | | | | |
| entrained) | | | | | |
| Xylene | — | — | — | — | 15.7 |
| Solventnaphtha ® | — | — | — | — | 5.3 |
| Solvent mixture: | | | | | |
| Solvent (A): | | | | | |
| n-Butanol | 10 | 5 | 5 | 5 | 8 |
| Solvent (B): | | | | | |
| (middle boilers) | | | | | |
| 1-Methoxypropanol | — | 6 | 4 | 6 | — |
| Butyl acetate 98/100% | 11 | 10 | 7 | 9 | — |
| Methyl amyl ketone | — | — | 4 | — | — |
| Ethyl ethoxy- | 5 | 5 | 5 | 4 | — |
| propionate | | | | | |
| Solvents (B): | | | | | |
| (high boilers) | | | | | |
| Butyl diglycol | — | — | — | 1 | — |
| Dibasic Ester ® | — | — | — | 1 | — |
| (DuPont) | | | | | |

^{a)}Copolymer comprising - based on the copolymer - 48% by weight n-butyl acrylate, 25% by weight styrene, and 27% by weight hydroxyethyl acrylate;
glass transition temperature Tg: −17.3° C.;
hydroxyl number: 130 mg KOH/g;
60% strength in Solvesso

The clearcoat materials of table 1 were stable on storage and were easy to apply by means of electrostatic spray coating (ESTA).

To assess the running behavior (number and length of runs) and the leveling, gloss and brightness, the clearcoat materials of table 1 were applied in wedge form to customary and known vertical perforated panels with a diagonal row of perforations and the panels were baked in vertical position at 130° C. for 30 minutes.

The run lengths at a film thickness of 55 μm were

17 mm (inventive example 1),

16 mm (inventive example 2),

19 mm (inventive example 3),

17 mm (inventive example 4), and

25 mm (comparative example C1).

This showed that the running behavior of the inventive clearcoat materials 1 to 4 was better than that of the. noninventive clearcoat material C1.

The leveling, surface smoothness, gloss, and brightness of the inventive clearcoats 1 to 4 and of the noninventive clearcoat C1 were assessed visually at highand low film thicknesses.

The leveling, surface smoothness, gloss, and brightness of the inventive clearcoats 1 to 4 were outstanding; in this respect they surpassed the noninventive clearcoat C1.

Within the series of the inventive clearcoats 1 to 4, at this outstanding level, there was also the following quality ranking:

High Film Thicknesses:

example 3>example 4>example 2>example 1

Low Film Thicknesses:

example 3>example 4>example 1>example 2

In other respects, the inventive clearcoats 1 to 4, especially as regards hardness, scratch resistance, chemical resistance, weathering stability, and etch resistance, were equal to the noninventive clearcoat C1.

1-6. (canceled)

7. A solventborne mixture comprising a binder and
(A) at least one low-boiling organic solvent and
(B) at least one organic solvent selected from the group consisting of high-boiling organic solvents and middle-boiling organic solvents,
wherein,
(1) at least one of the organic solvents (A) and/or (B) have a Hildebrand solubility parameter δ (HSP) of between 10.5 and 12.0 (cal/cm³)^{1/2} and a hydrogen bonding index (HBI) between −15 and −20, and
(2) at least one of the organic solvents (A) and/or (B) have a Hildebrand solubility parameter δ (HSP) of between 8 and 9.7 (cal/cm³)^{1/2} and a hydrogen bonding index (HBI) between 0 and 12,
wherein the solventborne mixture is curable by one of i) physically, ii) thermally, or iii) thermally and with actinic radiation.

8. The mixture of claim 7, wherein the at least one low-boiling organic solvent has a Hildebrand solubility parameter δ (HSP) of between 10.5 and 12.0 (cal/cm³)^{1/2} and a hydrogen bonding index (HBI) of between −15 and −20.

9. The mixture of claim 7, wherein the middle-boiling and the high-boiling organic solvent each have a Hildebrand solubility parameter δ of between 8 and 9.7 (cal/cm³)^{1/2} and a hydrogen bonding index (HBI) of between 0 and 12.

10-12. (canceled)

13. The mixture of claim 7, wherein the high-boiling organic solvents are selected from the group consisting of isotridecyl alcohol (ITA), isononanol, dibasic ester (DBE), butyl diglycol acetate (BDGA), 2,4-diethyl-1,5-octanediol (DEOD), and combinations thereof.

14. The mixture of claim 7, wherein the high-boiling organic solvents are selected from the group consisting of isotridecyl alcohol (ITA), dibasic ester (DBE), butyl diglycol acetate (BDGA), 2,4-dimethyl-1,5-octanediol (DEOD), and combinations thereof.

15. The mixture of claim 7, wherein the middle-boiling organic solvents are selected from the group consisting of glycolic acid butyl ester (GB ester), butyl aceate, pentyl acetate, ethoxypropyl acetate (EPA), 3-methoxybutyl acetate, ethyl ethoxypropionate (EEP), methyl amyl ketone (MAK), and combinations thereof.

16. The mixture of claim 7, wherein the middle-boiling organic solvents are selected from the group consisting of glycolic acid butyl ester (GB ester), butyl acetate, ethoxypropyl acetate (EPA), ethyl ethoxypropionate (EEP), methyl amyl ketone (MAK), and combinations thereof.

17. The mixture of claim 7, wherein the low-boiling organic solvents are selected from the group consisting of n-propanol, n-butanol, isobutanol, and combinations thereof.

18. The mixture of claim 7, wherein the low-boiling organic solvent comprises n-butanol.

19. The mixture of claim 7, wherein the mixture has less than 1% by weight aromatic solvent.

20. The mixture of claim 7, wherein the solventborne mixture is one of a coating materials, an adhesive, or a sealing compounds.

21. The mixture of claim 20, wherein the coating materials is one of a primer-surfacers composition, a solid-color topcoat materials, a basecoat materials, or a clearcoat materials.

22. The mixture of claim 7, wherein the mixture is free of aromatic solvent.

23. A method of making the solventborne mixture of claim 7 comprising adding a solvent mixture to the solventborne mixture, wherein the solvent mixture comprises
(A) the at least one low-boiling organic solvent and
(B) the at least one organic solvent selected from the group consisting of high-boiling and middle-boiling organic solvents.

24. The method of claim 23, wherein the at least one low-boiling organic solvent has a Hildebrand solubility parameter δ (HSP) of between 10.5 and 12.0 (cal/cm³)^{1/2} and a hydrogen bonding index (HBI) of between −15 and −20.

25. The method of claim 23, wherein the middle-boiling and the high-boiling organic solvent each have a Hildebrand solubility parameter δ of between 8 and 9.7 (cal/cm³)^{1/2} and a hydrogen bonding index (HBI) of between 0 and 12.
